(19) United States
(12) Patent Application Publication
(10) Pub. No.: US 2011/0051588 A1
(43) Pub. Date: Mar. 3, 2011

(54) PHOTO-CURING TYPE ADHESIVE, OPTICAL PICKUP UNIT AND MANUFACTURING METHOD THEREOF

(75) Inventors: Masayuki Okamura, Fujisawa (JP); Seiichi Kato, Tsuchiura (JP)

(73) Assignee: Hitachi Media Electronics Co., Ltd.

(21) Appl. No.: 12/765,467

(22) Filed: Apr. 22, 2010

(30) Foreign Application Priority Data
Aug. 31, 2009 (JP) 2009-199207

(51) Int. Cl. G11B 7/135; C08L 31/02; C08L 63/00; C08K 3/36; B05D 3/06

(52) U.S. Cl. 369/112.23; 524/556; 523/400; 523/466; 523/443; 427/516; G9B/7.112

(57) ABSTRACT

An adhesive agent, which contains a light starting agent and is cured by light, is added with fillers in which the difference in refractive indices between the adhesive agent and the fillers is not larger than ±0.02. Even if the adhesive agent is added with functional fillers, this addition method allows the suppression of a lowering in the light penetrability of the adhesive agent. As a result, it becomes possible to suppress the uncuring and shrinkage of the photo-curing type adhesive agent and to perform the bonding of components with high accuracy.

### INCORPORATION BY REFERENCE

The present application claims priority from Japanese application JP2009-199207 filed on Aug. 31, 2009, the content of which is hereby incorporated by reference into this application.

### BACKGROUND OF THE INVENTION

The present invention relates to a photo-curing type adhesive agent and its adhesion method. More particularly, it relates to an adhesive agent and its adhesion method for optical pickup units used for the recording and reproduction of optical recording media such as CDs (compact discs) and DVDs (digital versatile discs).

The optical pickup units included in optical-disc drive units are used for the recording and reproduction of the optical recording media such as CDs, DVDs, and Blu-ray (registered trademark) discs, in which adhesive agents are used for the fixing of optical components of an optical pickup unit such as mirrors and lenses. Also, most of the materials for these mirrors and lenses are such substances as polyolefin, acryl resins, and glasses. Meanwhile, such materials as metals (Zn, Mg, Al) and PPS (polyphenylene sulfide) are used as the materials for the optical-pickup case of the optical pickup unit. Moreover, in the case of optical components other than an objective lens, it becomes necessary to directly bond the optical components to the optical-pickup case from the viewpoint of low-cost and low-profile implementation of the optical pickup unit, so that the components and the optical-pickup case, whose materials are different from each other, are bonded to each other. As a result, depending on the physical and chemical property of the adhesive agent used, a lowering in adhesion strength such as adhesion peeling has become a serious problem.

In recent years, there has been a significant rise in the manufacturing and promotion of the optical pickup units designed for blue-violet semiconductor-laser based Blu-ray discs and optical-disc drive units into which these optical pickup units are integrated. In these pickup units and drive units, the density of the optical components become much higher as compared with the density in the cases of the optical recording media such as CDs and DVDs. As a result, in all the low-profile, very low-profile, and half-height pickup units and drive units, the component-mounting density becomes higher, and adhesion spaces become narrower. Also, the adhesive agent itself expands or shrinks due to changes in temperature and humidity of the surrounding environment. This expansion or shrinkage gives rise to position shifts of the optical components, thereby causing shifts of the optical-axis to occur. As a result, a tremendous lowering in the performance of the optical pickup units occurs. Accordingly, there is a necessity for developing an adhesive agent in which ultraviolet rays can penetrate into the adhesive agent sufficiently and the position shifts due to the thermal expansion is suppressed.

The general adhesive agents are produced from various organic materials such as acryl-based, epoxy-based, urethane-based, and silicon-based materials. In particular, in the acryl-based adhesive agents and epoxy-based adhesive agents which are often used in the manufacturing of electronic appliances, a problem has occurred that the adhesive agents themselves expand or shrink as a result of being influenced by the changes in the environment, in particular, changes in the temperature and humidity. Namely, in the epoxy-based adhesive agents and acryl-based adhesive agents which are commonly used at the time of bonding the optical appliances and components to each other, cured adhesive agents themselves expand because they absorb moisture contained in the atmosphere. Also, the volume of adhesive agent is caused to change by a temperature change as well: assuming that the volume change ratio is equal to 0 in their initial state, when the temperature is raised at one time and is then put back to the initial temperature, the volume shrinks without being restored to the initial volume. As a result, the position shifts of the optical components occur. As this position-shift accuracy for the optical components, μm-order accuracy has become necessary. Consequently, there is the necessity for developing an adhesive agent which is not influenced at all by the changes in the temperature and humidity of the adhesive agent itself.

As a countermeasure, it has been executed that a high value is added to an adhesive agent by adding a functional filler. In particular, by further adding the adhesive agent with a functional filler which has such properties as heat-liberation property and electrically-conductive property, it becomes possible to impart various functions to the adhesive agent.

Moreover, researches have been carried out concerning the development of an adhesive agent having a characteristic that these functions emerge, with only a small amount of addition by microminiaturizing the functional filler down into a nano size. The types of widely-used nano-size fillers range from fillers produced from inorganic materials such as glasses and silica to fillers at present produced from organic compounds such as fullerene and carbon nano-tube. Studies are being carried out that, of these substances, layer-structured clay minerals (i.e., clays) existing in the natural world are used as the fillers.

The main constituents of the clays are SiO₂, Al₂O₃, and MgO, and their structure is a layer-like structure as is illustrated in FIG. 9. Generally, the clay-like minerals (e.g., montmorillonite, saponite, and smectite) are of a sheet-like structure, and have exceedingly large aspect ratios. The surface of the layer-like sheets is coated with a silane coupling agent including Si in order to enlarge this inter-layer distance d, thereby making it possible that the clay-like minerals disperse easily into the adhesive agent. Thus an enhancement of the physical and chemical property of the adhesive agent is aimed. In this way, by mixing/kneading and dispersing functional fillers having various functions into an adhesive agent, it becomes possible to easily impart the various functions to the adhesive agent.

Incidentally, as prior-art technical documents associated with the present invention, the following patent documents exist:

In JP-A-05-287224, it is described that even an about 200-μm-thick coating film can sufficiently be cured by adding an ultraviolet-ray-curing type paint with a sphere-like filler having a particle diameter of 100 μm or less by an amount of 10 to 50%. No description, however, is given concerning the relationship in the refractive indices between the filler and the paint.

In JP-A-2007-277419, the description is given regarding a vibration-controlling cohesive-agent composite substance which is formed by the simultaneous addition of a plate-like filler having an aspect ratio of 10 or larger and a thickness of 100 nm or less and a sphere-like filler having an average particle-diameter of 100 nm or less. However, the cohesive agent is used as the base agent, so that, unlike the case of an adhesive agent, no consideration is given to the curing of the cohesive agent and the fixing of bonded units with sufficient adhesion strength therebetween being maintained.

### SUMMARY OF THE INVENTION

However, when a photo-curing type adhesive agent used is added with a functional filler as described above, the light penetrability of the adhesive agent lowers in some cases.

In particular, in an optical pickup unit designed for the Blu-ray discs, the number of the optical components becomes exceedingly large, and thus the packaging density becomes extremely high. Accordingly, the distances between the optical components and the optical-pickup case have become extremely short. In addition, the addition of a functional filler into a photo-curing type adhesive agent lowers the light penetrability of the adhesive agent. As a result, ultraviolet rays cannot penetrate into the adhesive agent sufficiently, so that there is a concern that the curing time delays and that the adhesive agent remains uncured. As a consequence, quality failures due to a lowering in the adhesion strength and the position shifts become a serious problem in some cases.

An object of the present invention is to provide the following photo-curing type adhesive agent in which, even when added with a functional filler having other functions such as a reduced thermal shrinkage ratio and a reduced penetration property of the water-vapor, it becomes possible to impart the functions to the adhesive agent in an advantageous manner that a lowering in the ultraviolet-ray transmissivity of the adhesive agent can be suppressed.

In order to accomplish the above-described object, in the present invention, an adhesive agent, which contains a light starting agent and is cured by light, is added with a filler in which the difference in the refractive indices between the adhesive agent and the functional filler becomes smaller than ±0.02.

According to the present invention, even when the adhesive agent is added with functional fillers, light can reach not only the surface of the adhesive agent but also down to its deep portion, so that it becomes possible to reduce the quality failure due to the uncuring of the adhesive agent. This feature makes it possible to provide an optical pickup unit with high productivity and stable quality.

Other objects, features and advantages of the invention will become apparent from the following description of the embodiments of the invention taken in conjunction with the accompanying drawings.

### BRIEF DESCRIPTION OF THE DRAWINGS

FIG. 1 is an explanatory diagram for illustrating a first embodiment of the present invention;

FIG. 2 is a schematic diagram for illustrating the relationship between the difference in the refractive indices between the photo-curing type adhesive agent and the functional filler, and the ultraviolet-ray transmissivity of the adhesive agent in the first embodiment of the present invention;

FIG. 3 is a schematic diagram for illustrating the result of adhesion-strength measurement in the first embodiment of the present invention;

FIG. 4 is a schematic diagram for illustrating the result of viscosity measurement in the first embodiment of the present invention;

FIG. 5 is a schematic diagram for illustrating the result of the size-change-ratio measurement in the first embodiment of the present invention;

FIG. 6 is an explanatory diagram for illustrating a second embodiment of the present invention;

FIG. 7 is a schematic diagram for illustrating the result of thermal conductivity in a third embodiment of the present invention;

FIG. 8 is a top-view diagram for illustrating the general mode of an optical pickup unit according to the present invention;

FIG. 9 is the explanatory diagram for illustrating general morphology of a layer-structured clay mineral in the comparison example 1 and the second embodiment of the present invention;

FIG. 10 is an explanatory diagram for illustrating a fourth embodiment of the present invention;

FIG. 11 is an explanatory diagram for illustrating a fifth embodiment of the present invention;

FIG. 12 is an explanatory diagram for illustrating a sixth embodiment of the present invention; and

FIG. 13 is an explanatory diagram for illustrating a seventh embodiment of the present invention.

### DETAILED DESCRIPTION OF THE INVENTION

### 1st Embodiment

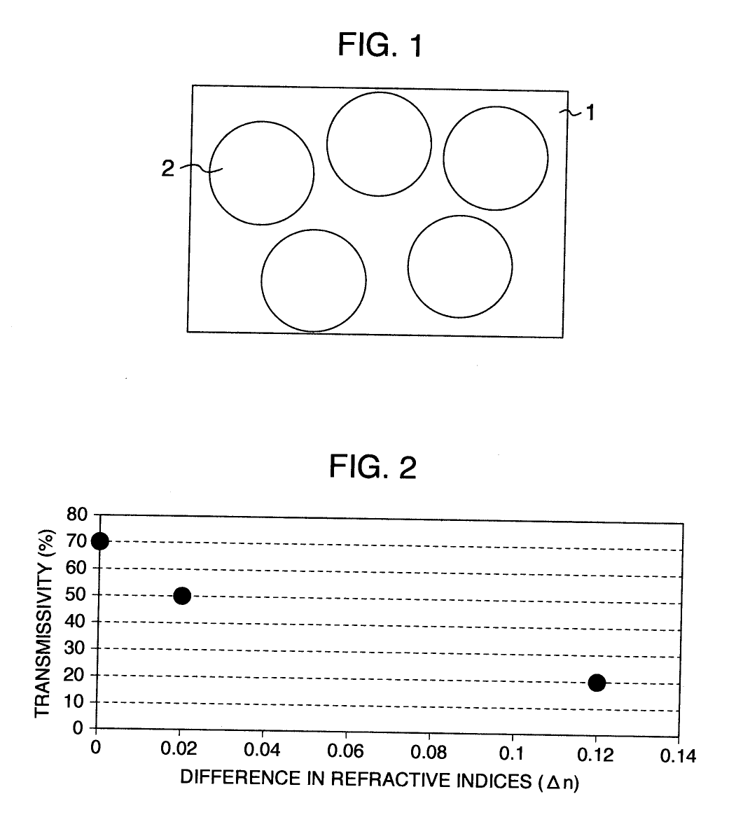

An adhesive agent illustrated in FIG. 1 has been produced. An ultraviolet-ray-curing type acryl-based adhesive agent 1 (refractive index: 1.49) containing a light starting agent was used as the adhesive agent which becomes the base. This adhesive agent is of the light penetrability. This adhesive agent is added with sphere-like fillers 2 having an average radius of 50 μm. The material of which is glass (main constituent: SiO₂, refractive index: 1.51) and the difference in the refractive indices between the adhesive agent 1 and the fillers 2 is smaller than 0.02. The adding amounts of the fillers 2 into the adhesive agent 1 are equal to 2 wt %, 5 wt %, 10 wt %, and 15 wt %. The mixing/kneading of the fillers 2 and the adhesive agent 1 was performed for 5 minutes under 101 kPa and 1000 rpm using a rotation/revolution vacuum mixer (Awatori Neritaro) manufactured by THINKY CORPORATION.

Table 1 shows the result of curing-depth measurement on the adhesive agent added with the fillers 2 when the ultraviolet-ray irradiation intensity is set at a constant value, of 100 mW/cm², when the ultraviolet-ray irradiation time is changed from 10 seconds, 20 seconds, to 30 seconds. The curing-depth measurement was made as follows: A tube having an inner-radius of 5 mm and an outer-radius of 8 mm composed of polyvinyl chloride was coated with the adhesive agent, and cured. After that, only the cured portion is removed by ultrasound washing in acetone. The length ranging from the irradiation surface to the end of the cured portion was measured and defined as the curing depth. It was found that there is almost no change between the curing depth with the base adhesive agent 1 alone and the curing depth with the base adhesive agent 1 added with the sphere-like fillers 2.

TABLE 1
Table 1

| | sphere-like-fillers | | | |
|---|---|---|---|---|
| embodiment 1 | adding amount (wt %) | curing depth (mm) | | |
| UV irradiation | | 10 | 20 | 30 |
| time (s) | | | | |
| acryl-based | 0 | 3.472 | 4.591 | 5.238 |
| adhesive agent | | | | |
| alone | | | | |
| sphere-like | 2 | 3.396 | 4.544 | 5.205 |
| fillers 2 (wt %) | | | | |
| sphere-like | 5 | 3.388 | 4.497 | 5.024 |
| fillers 5 (wt %) | | | | |
| sphere-like | 10 | 3.333 | 4.41 | 5.299 |
| fillers 10 (wt %) | | | | |
| sphere-like | 15 | 3.381 | 4.458 | 5.063 |
| fillers 15 (wt %) | | | | |

As a first comparison example, the curing-depth measurement has been made with the use of the adhesive agent 1 added with clay fillers 3 (refractive index: 1.56). The difference in the refractive indices between the adhesive agent 1 and the clay fillers 3 is larger than 0.02. The clay employed is a commercially available clay whose surface is modified with a silane coupling agent. For example, Esben-NX silane processing provided by HOJUN Co., LTD. is employed. This clay includes Si that makes a Si—O chemical bonding on the clay surface and was covered with organic molecules terminated with a methyl group and the carbon number of which is in a range of 3 to 18 in order to enlarge the inter-layer distance and to make this clay easier to dissolve into the solvent. The mixing/kneading was performed for 5 minutes with 101 kPa and 1000 rpm, using the same rotation/revolution vacuum mixer as the one in the first embodiment.

Table 2 shows the result of the curing-depth measurement when the above-described ultraviolet-ray-curing type acryl-based adhesive agent is used as the base adhesive agent 1 and when the adhesive agent 1 is added with the clay fillers 3 by an amount of various weight percents. The measurement method is basically the same as the one in the adhesive agent added with the above-described sphere-like fillers 2: The irradiation intensity was set at the constant value of 100 mW/cm², and the irradiation time was changed from 10 seconds, 20 seconds, to 30 seconds. It was found that, the larger the adding amount of the clay fillers 3 becomes, the shallower the curing depth becomes. In this way, it was found that the addition of the sphere-like fillers 3 into the adhesive agent 1 causes almost no change to occur in the ultraviolet-ray penetrability of the adhesive agent 1. The reasons may be considered that the difference in the refractive indices between the fillers 3 and the adhesive agent 1 is small, and random reflection and light scattering on the surfaces of the sphere-like fillers 3 can be suppressed since and the shape of the fillers 3 is sphere-like.

TABLE 2
Table 2

| comparison | clay-fillers adding | | | |
|---|---|---|---|---|
| example 1 | amount (wt %) | curing depth (mm) | | |
| UV irradiation | | 10 | 20 | 30 |
| time (s) | | | | |
| acryl-based | 0 | 3.472 | 4.591 | 5.238 |
| adhesive agent | | | | |
| alone | | | | |
| clay fillers 2 | 2 | 3.278 | 4.002 | 4.623 |
| (wt %) | | | | |
| clay fillers 5 | 5 | 3.09 | 3.664 | 3.947 |
| (wt %) | | | | |
| clay fillers 10 | 10 | 2.547 | 2.972 | 3.208 |
| (wt %) | | | | |
| clay fillers 15 | 15 | 2.327 | 2.657 | 2.618 |
| (wt %) | | | | |

FIG. 2 is a schematic diagram for illustrating the relationship between the difference in the refractive indices between the ultraviolet-ray-curing type acryl-based adhesive agent and fillers, and the ultraviolet-ray transmissivity of the adhesive agent. The larger the difference in the refractive indices becomes, the lower the ultraviolet-ray transmissivity becomes. If the refractive indices differ by an amount of 0.1 or more, ultraviolet rays can penetrate into the adhesive agent by an amount of only about 30%. Accordingly, if the adhesive agent and the fillers are selected so that the difference in the refractive indices therebetween becomes smaller than ±0.02, the ultraviolet ray is allowed to penetrate into the adhesive agent by an amount of at least 50% or more, thereby making it possible to cure the adhesive agent down to the depth thereof sufficiently.

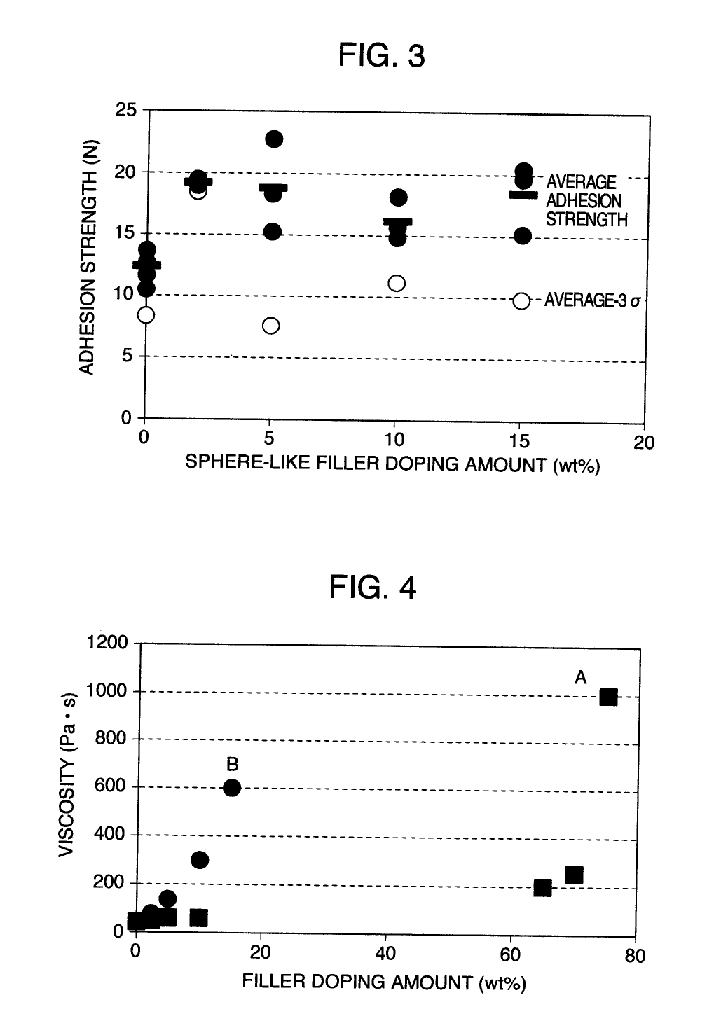

FIG. 3 represents the result of the adhesion-strength measurement when the adhesive agent 1 is added with the sphere-like fillers 2 in which the difference in the refractive indices between the adhesive agent 1 and the sphere-like fillers 2 is smaller than ±0.02. The substances employed to be bonded were aluminum and plastic, and the tensile strength therebetween was measured. It could be confirmed that increasing the adding amount of the fillers 2 results in no lowering in the adhesion strength. Consequently, it could be confirmed that there occurs no lowering in the adhesion strength caused by the addition of the fillers 2, and that the ultraviolet ray has successfully reached down to the deep portion at the location applied with the adhesive agent.

FIG. 4 represents the result of the viscosity measurement before-curing when the adding amounts of the above-mentioned fillers are increased. In the viscosity measurement, a cone-plate-type viscometer was used, and the measurement temperature was set at 25° C. FIG. 4 represents the result of viscosity measurement at 2 rpm. The notation A indicates the result in a case of the addition with the sphere-like fillers 2 alone in which the difference in the refractive indices between the adhesive agent 1 and the fillers 2 is smaller than ±0.02, while the notation B indicates the result in a case of the addition with the clay fillers 3. From the result of this viscosity measurement, it was found that the viscosity increases gradually in accordance with the increase in the adding amount of the sphere-like fillers 2, and that the viscosity increases steeply when added with a 70-wt % sphere-like fillers 2. On the other hand, it was found that, when added with the clay fillers 3, the viscosity increases sufficiently with only about a 10-wt % addition of the clay fillers 3. In this way, in some type of fillers such as the clay fillers, only about the 10-wt % addition thereof gives rise to an occurrence of too large viscosity, thereby resulting in a concern that the operability may become worse. Accordingly, it was found that the optimum value of the adding amount of the sphere-like fillers 2 is equal to 70 wt % or less as shown in Table 1 where the viscosity is 300 Pa·s or less.

The adhesive agents usable are the acryl-based or epoxy-based adhesive agents. Since the refractive index of the acryl-based or epoxy-based adhesive agents is usually equal to about 1.40 to 1.70, it is desirable to use as inorganic materials, aluminum, aluminum oxide (alumina), calcium hydroxide, calcium carbonate, sodium metasilicate, barium carbonate, barium fluoride, calcium fluoride, magnesium carbonate, magnesium hydroxide, quarts, and glass. Also, as organic materials, it is desirable to use melamine resin, nylon, polystyrene, polyethylene, vinyl resin, and fluorine resin.

Also, in the present embodiment, the machines usable as the mixing/kneading methods for the fillers are ribbon mixer, pressure-applying kneader, double-screw pushing machine, three-roll mill, beads mill, and the rotation/revolution vacuum mixer. Although no specific mixing/kneading machine is necessarily selected, the use of the rotation/revolution vacuum mixer is desirable.

Also, in the present embodiment, although radiations such as visible light, ultraviolet rays, and infrared rays are available as light-source radiations for curing the adhesive agents, the use of ultraviolet rays is desirable.

As having been described so far, in the present embodiment, the difference in the refractive indices between the adhesive agent and the fillers is made smaller than ±0.02. This feature makes it possible to suppress the lowering in the transmissivity of the light for curing the adhesive agent.

### 2nd Embodiment

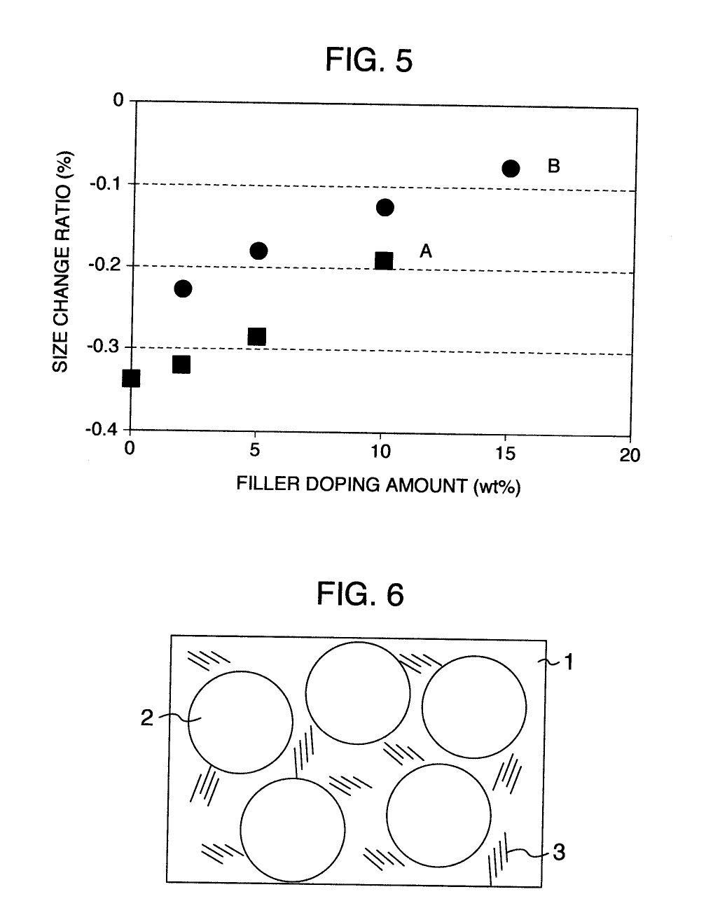

Under an assumption that an adhesive agent added with the sphere-like fillers 2 as described in the first embodiment is further added with the clay fillers 3 as in the first comparison example, the thermal machine analysis (TMA) was made concerning a cured substance resulting from the adhesive agent added with both the sphere-like fillers 2 and the clay fillers 3, and the size change ratio before and after the heat application was measured. The size of the sample was 4 mm×4 mm×10 mm, and the sample was cured by irradiating the sample with a 200 mW/cm²-intensity ultraviolet ray for 60 seconds. The TMA measurement was made under a compression condition applied onto the long-axis side, and the applied weight was set at 5 gf. The cured adhesive agent was heated from room temperature to 70° C., then being held at 70° C. for 2 hours and was put back to room temperature. Then a difference in the expansion/shrinkage between before the measurement and after the heat treatment was defined as the size change ratio, and FIG. 5 is a diagram thereof where the transverse axis denotes the fillers addition amount and the longitudinal axis denotes the size change ratio.

It was found that the addition of a small amount of the clay fillers 3 makes it possible to suppress the size change ratio due to the heat treatment, and also that this size-change-ratio suppression effect is exceedingly large. Also, the larger the adding amount of the clay fillers 3 becomes, the smaller the size change ratio becomes. For example, the addition of the 10-wt % clay fillers 3 resulted in a size change ratio equal to 20% of the size of the original adhesive agent.

Even the addition of the sphere-like fillers 2 has also resulted in the size-change-ratio reduction effect, but the reduction effect in this case was smaller than in the case of the addition of the clay fillers 3. A possible reason for this is that, since the clay fillers 3 are of nano-size so that the clay fillers 3 become equal to or smaller than an oligomer of the adhesive agent 1, the adhesion property of the clay fillers 3 with the adhesive agent increases. As a result, the clay fillers 3 obstruct the shrinkage of the adhesive agent due to the heat treatment, because the clay fillers 3 themselves are rigid. In this way, both the sphere-like fillers 2 and the clay fillers 3 exhibit the heat-shrinkage reduction effect on the adhesive agent. However, as shown in Table 2, the addition of the clay fillers 3 alone results in the occurrence of the significant lowering in the curing-depth property only with the addition of 10 wt % or less. Nevertheless, as illustrated in FIG. 6, in an adhesive agent added with the ultraviolet-ray penetrable sphere-like fillers 2 is further added with the clay fillers 3 by the amount of 2 to 10 wt %, ultraviolet rays can penetrate the sphere-like fillers 2, and consequently, it becomes possible to cause this adhesive agent to exhibit the reduction effect on the heat-shrinkage up to the fullest extent without decreasing the ultraviolet-ray penetrability.

In the present embodiment, the photo-curing type adhesive agent contains a layer-structured clay mineral whose main constituent is silica, and in which at least one side of the layer is in the range of 100 nm to 500 nm and the thickness of a piece of sheet thereof is thinner than 2 nm. In addition, a layer-structured clay mineral is used whose surface is at least covered with organic molecules. Further, the photo-curing type adhesive agent contains at least 2-wt % to 10-wt % clay covered with organic molecules.

In the present embodiment, it is desirable to use, as the layer-structured clay mineral, clay minerals such as kaolinate, pyrophanite, tarque, montmorillonite, saponite, halloysite, chrysotite, vermiculite, mica, and margarite. Also, in the present invention, it is desirable that the surface of the layer-structured clay mineral is covered with a silane coupling agent whose carbon number is in the range of 3 to 16.

### 3rd Embodiment

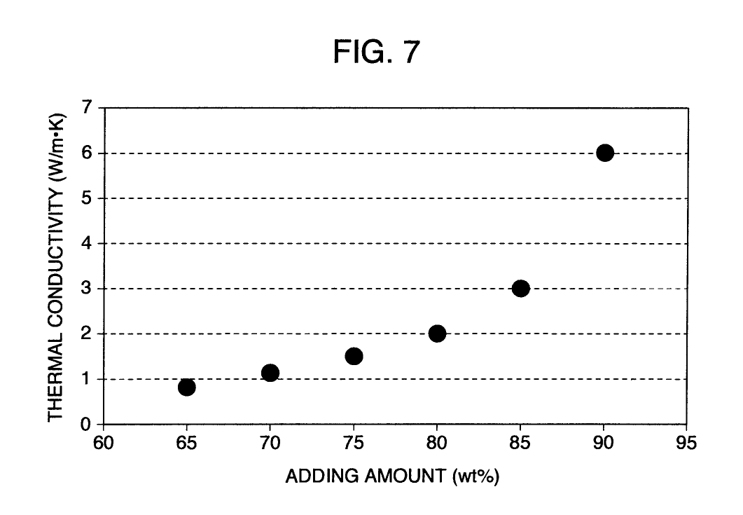

FIG. 7 represents the relationship between the thermal conductivity and the adding amount when a sphere-like fillers composed of alumina (refractive index: 1.76) was used. Here, a case was assumed that there exist the alumina fillers in which the difference in the refractive indices between the adhesive agent and the alumina fillers is smaller than ±0.02. It was found that, the larger the fillers adding amount becomes, the higher the thermal conductivity becomes. In particular, the thermal conductivity enhances significantly when the adding amount of the alumina-fillers addition is 70 wt % or more. Since the thermal conductivity of alumina is 36 W/m·K, which is larger as compared with the other substances, and its cost is lower, alumina is a substance exceedingly easy to use. Consequently, when a high-thermal-conductivity organic substance like alumina is employed as the fillers, it becomes possible to enhance the ultraviolet-ray penetrability as well as the thermal conductivity of the adhesive agent.

### 4th Embodiment

FIG. 10 is a schematic illustration of the adhesive agent which is simultaneously added with the ultraviolet-ray penetrable sphere-like fillers 2 and needle-like fillers 12. In order to verify the effects resulting from the addition of the needle-like fillers 12, a measurement was made concerning changes in the heat shrinkage amount and the linear expansion coefficient when the photo-curing type adhesive agent 1 is added with the needle-like fillers 12. The needle-like fillers 12 are commercially available as various materials and shapes. The needle-like fillers 12 employed this case are Arvorex composed of aluminum borate having a 1-μm diameter and a length of 10-μm to 30-μm, produced by SHIKOKU CHEMICALS CORPORATION.

With only a 10-wt % addition of the needle-like fillers 12, the heat shrinkage amount decreased by an amount of 30% as compared with the original adhesive agent. Also, the linear expansion coefficient was 125 ppm, namely, the linear expansion coefficient decreased by an amount of about 20% as compared with the linear expansion coefficient (150 ppm) of the original adhesive agent. From these measurement results, it becomes possible to reduce the linear expansion coefficient of the adhesive agent designed for the optical pickup, by further adding the needle-like fillers 12, capable of reducing the linear expansion coefficient with the small amount of addition as described above, to the adhesive agent the ultraviolet-ray penetrability of which was improved by adding the sphere-like fillers 2 in which the difference in the refractive indices between the adhesive agent and the fillers 2 is smaller than 0.02.

Consequently, by producing the adhesive agent as illustrated in the schematic diagram in FIG. 10, and simultaneously added with the ultraviolet-ray penetrable sphere-like fillers 2 and the needle-like fillers 12, it becomes possible to produce the adhesive agent which allows the suppression of the lowering in the ultraviolet-ray penetrability, and which allows the suppression of the expansion/shrinkage due to heat.

In the present embodiment, as the needle-like fillers 12, it is desirable to use materials such as graphite, potassium titanate, alumina-based material, silicon carbide, silicon nitride, mullite, magnesia, magnesium borate, zinc oxide, and titanium boride (TiB₂).

Also, in the present invention, as fibrous fillers, it is desirable to use substances such as carbon fiber, glass fiber, and metal fibers of stainless, iron, gold, silver, and aluminum.

### 5th Embodiment

FIG. 11 is a schematic illustration of the adhesive agent which is simultaneously added with the fibrous fillers 13 and the ultraviolet-ray penetrable sphere-like fillers 2 in which the difference in the refractive indices between the adhesive agent and the sphere-like fillers 2 is smaller than ±0.02. The addition of the fibrous fillers 13 into the adhesive agent enables an enhancement in the tensile strength and stiffness and a reduction in the thermal expansion, because the fibers are entangled with each other inside the adhesive agent. On the other hand, the addition of the fibrous fillers 13 generates a possibility that the ultraviolet-ray penetrability into the adhesive agent will become lowered. However, the addition of the ultraviolet-ray penetrable sphere-like fillers 2 prevents the occurrence of the uncuring of the adhesive agent caused by the lowering in the ultraviolet-ray transmissivity of the adhesive agent, and thus the above-described effects resulting from the addition of the fibrous fillers 13 can be emerged.

### 6th Embodiment

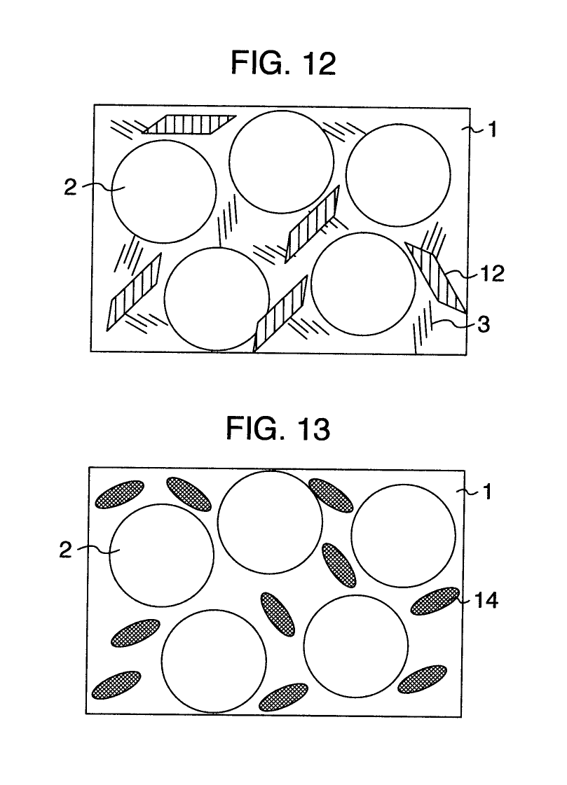

FIG. 12 is a schematic illustration of the adhesive agent which is simultaneously added with the sphere-like fillers 2, in which the difference in the refractive indices between the adhesive agent and the sphere-like fillers 2 is smaller than ±0.02, the clay fillers 3, and the needle-like fillers 12. The respective fillers possess different functions, namely, enhancing the ultraviolet-ray penetrability, lowering in the heat shrinkage, lowering water penetration, and lowering the linear expansion coefficient, respectively. The addition of the clay fillers 3 and the needle-like fillers 12 into the ultraviolet-ray-curing type adhesive agent results in a concern that, as is shown in Table 2, the ultraviolet-ray penetrability may become lowered. Accordingly, by adding the adhesive agent with the sphere-like fillers 2, it becomes possible to produce the adhesive agent which permits all the functions of the respective fillers to emerge without lowering the ultraviolet-ray penetrability.

### 7th Embodiment

FIG. 13 is a schematic diagram for illustrating the adhesive agent which is simultaneously added with the sphere-like fillers 2 in which the difference in the refractive indices between the adhesive agent and the sphere-like fillers 2 is smaller than ±0.02, and metallic fillers 14. The addition of the metallic fillers 14 into the adhesive agent 1 makes it possible to impart the electrically-conductive property to the adhesive agent 1. If, however, the metallic fillers 14 are sufficiently small, the curing of the ultraviolet-ray-curing type adhesive agent 1 being the base agent becomes possible, because the sphere-like fillers 2 permits ultraviolet rays to penetrate. Consequently, although electrically-conductive adhesive agents are generally limited to the heat-curing type, the photo-curing type electrically-conductive adhesive agent as illustrated in FIG. 13 becomes producible.

It is desirable to use, as the metallic fillers or semiconductor fillers, metallic particles such as silver, copper, gold, tin, and nickel, and semiconductor particles such as CdTe, CdS, ZnO, and TiO₂.

### 8th Embodiment

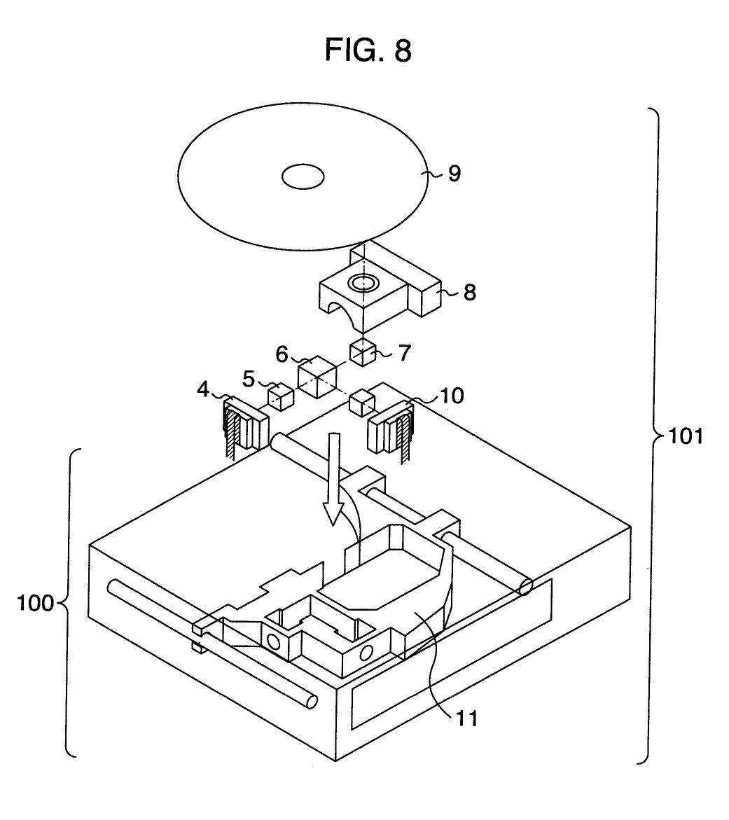

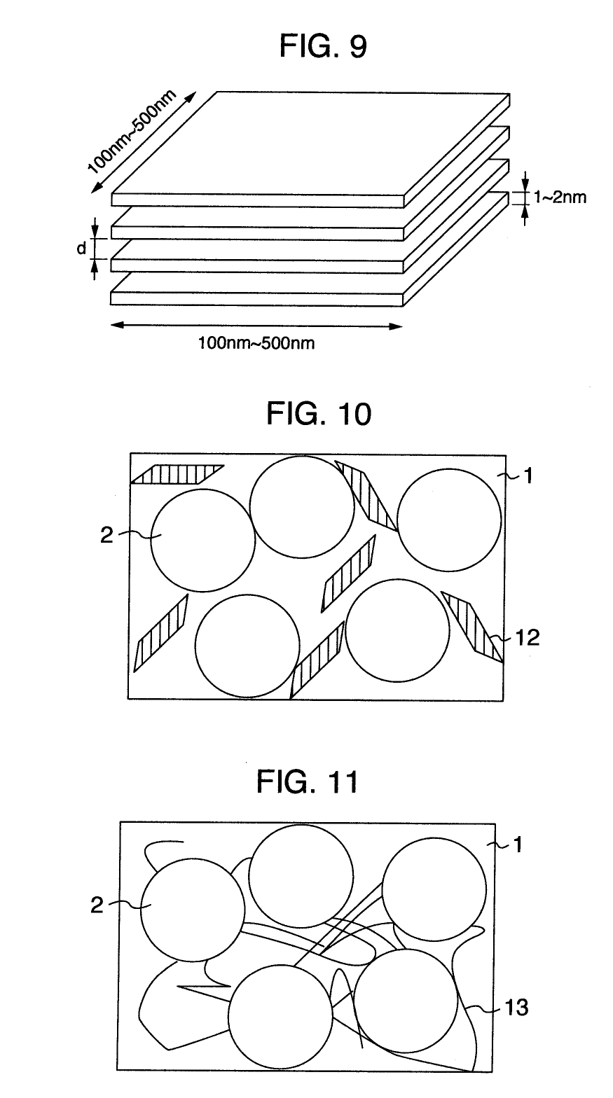

FIG. 8 is a schematic diagram for illustrating an optical pickup unit 100 and an optical-disc drive unit 101. The optical pickup unit includes an optical system in which emitted light from a light-emitting device 10 such as laser diode is introduced to an objective lens via various types of lenses 5, prisms 6, and mirrors 7, and thus the light is focused onto an optical recording medium, and the other optical system in which return light from the optical disc 9 is received by a photoelectric conversion device (light-receiving device) 4 for converging the optical output into an electrical signal via the objective lens, the lenses 5, the prisms 6, and the mirrors 7. Of these components, the optical components such as the various types of lenses are required to be fixed using the adhesive agent at positions optimum from the optical point-of-view with respect to an optical-pickup case 11. In the pickup unit, the stable read-out and write-in of signals from/into the optical disc is made possible by maintaining the distance between the objective lens and the optical-disc surface at a constant value by using an actuator 8 and finely adjusting the height of the objective lens with respect to optical-disc media according to various standards and the optical disc 9 which generates surface blurring due to a warping of the optical disc.

In the present embodiment, the above-described optical components such as the light-emitting device 10, various types of lenses 5, prisms 6, and mirrors 7 are bonded to the housing by using the adhesive agent explained in the first to seventh embodiments. This bonding is performed such that clearances between the optical components and the housing are applied with the adhesive agent, and after that, the adhesive agent is irradiated with light for curing. Although the adhesive agent used is added with the functional fillers, the lowering in the light penetrability is suppressed. This feature allows the adhesive agent to be cured quickly, thereby making it possible to perform the bonding with suppressing the uncuring and shrinkage of the adhesive agent.

Since the bonding thickness for the optical components of the optical pickup unit is generally thinner than 500 μm, if the maximum length of the fillers is shorter than 500 μm, no problem occurs in their use. In a portion where the bonding thickness becomes thinner than it, it is desirable to use fillers whose maximum length is shorter than a target bonding thickness.

The bonding of the optical components used in the optical pickup unit is one of the important factors which exert significant influences on the optical characteristics of the units. In view of this situation, the technology, which allows reduction in position shifts of the optical components due to their bonding, and which allows the adhesive agent to be cured sufficiently down to the depth of adhesion locations so that their optimum positions can be maintained with high position accuracies, is an important technology for accomplishing yield enhancement, lowering the cost by the fabrication-time shortage, and high-performance. This technology is applicable to light-using units such as, e.g., next-generation optical communication units, in which optical components are required to be fixed and position shifts of the optical components become a serious problem.

It should be further understood by those skilled in the art that although the foregoing description has been made on embodiments of the invention, the invention is not limited thereto and various changes and modifications may be made without departing from the spirit of the invention and the scope of the appended claims.

1. A photo-curing type adhesive agent containing a light starting agent and cured by light, comprising:
an adhesive agent which is a base agent; and
first fillers in which difference in refractive indices between said adhesive agent and said first fillers is not larger than 0.02.

2. The photo-curing type adhesive agent according to claim 1, further comprising:
second fillers which are different from said first fillers in which difference in refractive indices between said adhesive agent and said second fillers being larger than 0.02.

3. The photo-curing type adhesive agent according to claim 1, wherein said photo-curing type adhesive agent contains said first fillers by an amount of 1 wt % to 70 wt %.

4. The photo-curing type adhesive agent according to claim 1, wherein maximum length of said first fillers is not longer than 500 μm.

5. The photo-curing type adhesive agent according to claim 1, wherein inequality of surfaces of said first fillers are not longer than 1 μm in length.

6. The photo-curing type adhesive agent according to claim 1, wherein shape of said first fillers is sphere-like.

7. The photo-curing type adhesive agent according to claim 1, wherein material of said first fillers is composed of an inorganic substance or an organic substance.

8. The photo-curing type adhesive agent according to claim 1, wherein said adhesive agent, which is said base agent, is an acryl-based or epoxy-based adhesive agent.

9. The photo-curing type adhesive agent according to claim 2, wherein said second fillers contain a layer-structured clay mineral whose main constituent is silica.

10. The photo-curing type adhesive agent according to claim 9, wherein at least one side of said layer-structured clay mineral is in a range of 100 nm to 500 nm and thickness of a piece of sheet of said clay mineral is not thicker than 2 nm.

11. The photo-curing type adhesive agent according to claim 9, wherein the surface of said layer-structured clay mineral is covered with organic molecules.

12. The photo-curing type adhesive agent according to claim 9, wherein said second fillers contain said layer-structured clay mineral by an amount of 2 wt % to 10 wt %.

13. The photo-curing type adhesive agent according to claim 2, wherein said second fillers are needle-like fillers having a diameter in a range of 0.5 μm to 1 μm and a length along a major axis in a range of 30 μm to 50 μm.

14. The photo-curing type adhesive agent according to claim 2, wherein said second fillers are fibrous fillers.

15. The photo-curing type adhesive agent according to claim 1, wherein said adhesive agent is added with fillers made from metal or semiconductor.

16. An optical pickup unit, comprising:
a light-emitting device;
a light-receiving device;
an objective lens;
a prism;
a mirror;
a housing; and
said photo-curing type adhesive agent claimed in claim 1, wherein said photo-curing type adhesive agent is used for bonding said housing to any one of said light-emitting device, said light-receiving device, said objective lens, said prism, and said mirror.

17. A method of manufacturing an optical pickup unit, comprising the steps of:
applying said photo-curing type adhesive agent claimed in claim 1 to a clearance between a first optical component and a second optical component with; and
curing said photo-curing type adhesive agent by irradiating said photo-curing type adhesive agent with light.
